(19) United States
(12) Patent Application Publication
(10) Pub. No.: US 2005/0239501 A1
(43) Pub. Date: Oct. 27, 2005

(54) Method for provisioning compatible interoperation information for a private branch exchange

(75) Inventors: Ajaykumar R. Idnani, Schaumburg, IL (US); Anatoly S. Belkin, Glenview, IL (US); Mark D. Hamlen, Palatine, IL (US); Rajendra A. Panchal, Algonquin, IL (US); Imran Raza, Lake Worth, FL (US); Srinath Subramanian, Davie, FL (US); Tracy L. Wolf, Schaumburg, IL (US)

Correspondence Address: MOTOROLA, INC., 1303 EAST ALGONQUIN ROAD, IL01/3RD, SCHAUMBURG, IL, 60196, US

(73) Assignee: Motorola, Inc.

(21) Appl. No.: 10/831,995

(22) Filed: Apr. 26, 2004

(51) Int. Cl. H04M 1/00

(52) U.S. Cl. 455/554.2; 455/554.1; 455/426.2

(57) ABSTRACT

Fixed network equipment associated with a given private branch exchange provides, and a mobile communication device receives, information that corresponds to compatible interoperation with that private branch exchange, including, for example, a plurality of identifiers including a logical identifier that corresponds to compatible interaction with the private branch exchange. Thereafter, when seeking facilitation of services via that private branch exchange, the mobile communication device can use that logical identifier.

### FIELD OF THE INVENTION

This invention relates generally to wireless communication systems and more particularly to wireless communication systems that are operably associated with a private branch exchange.

### BACKGROUND OF THE INVENTION

Wireless communication systems of various kinds are known in the art, with cellular and 802.11-family networks comprising presently ubiquitous examples. Many such systems support the provision of services to roaming and/or multi-system mobile wireless devices. Such support often entails access to and compatible operation with a private branch exchange. Unfortunately, at least at present, private branch exchanges as offered by various manufacturers can and do differ from one another. Such differences can lead to varied requirements regarding various interoperablity procedures such as, but not limited to, communication protocols. For example, a given private branch exchange will typically accept only a single given identifier (and/or identifier format) for a given corresponding wireless mobile device.

There is, at present, no universally accepted identifier/identifier-format to facilitate such private branch exchange operations. This includes session initiation protocol-based compliant private branch exchanges. Although a basic session initiation protocol format may be substantially identical from one platform to another, the identifier content portion requirements of that session initiation protocol-based identifier will still often vary from platform to platform.

This of course can lead to impediments and problems. At worst, these conditions prompt the designers of wireless mobile devices to provide a custom subscriber solution for each private branch exchange platform and/or to require device reprogramming whenever the user moves from one system associated with a first private branch exchange to another system associated with a different private branch exchange. Such solutions potentially require one or more of an inappropriate allocation of resources, expense, time, bandwidth, and/or training and overhead.

### BRIEF DESCRIPTION OF THE DRAWINGS

The above needs are at least partially met through provision of the method for provisioning compatible interoperation information for a private branch exchange described in the following detailed description, particularly when studied in conjunction with the drawings, wherein:

FIG. 1 comprises a flow diagram as configured in accordance with various embodiments of the invention;

FIG. 2 a block diagram as configured in accordance with various embodiments of the invention;

FIG. 3 comprises a flow diagram as configured in accordance with various embodiments of the invention; and

FIG. 4 comprises a block diagram as configured in accordance with various embodiments of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION OF THE INVENTION

Generally speaking, pursuant to these various embodiments, an element (or elements) of fixed network equipment for a communication system determines, for a given mobile communication unit, private branch exchange information that corresponds to compatible interoperation with a given private branch exchange. For example, the element can identify a plurality of identifiers including a logical identifier that corresponds to a given private branch exchange. This element then facilitates the transmission of such identifier information to that given mobile communication unit. Upon receiving this transmission, the mobile communication unit stores these identifiers and uses them appropriately in subsequent communications. In particular, the mobile communication unit uses the logical identifier when effecting communications via the private branch exchange.

So configured, the fixed network equipment for a given system can provide a mobile communication unit with information useful or necessary to establish compatible interoperation with a given private branch exchange. As one example, by providing the above noted identifer(s), the network element essentially controls the identity used by the mobile communication unit and particularly controls the identity used by the mobile communication unit when effecting communications via the private branch exchange that is associated with that fixed network equipment. This approach tends to assure compatible operations while avoiding the need for custom mobile platform solutions and/or more invasive mobile platform reprogramming.

These and other benefits will become more evident to those skilled in the art upon making a thorough review and study of the following detailed description.

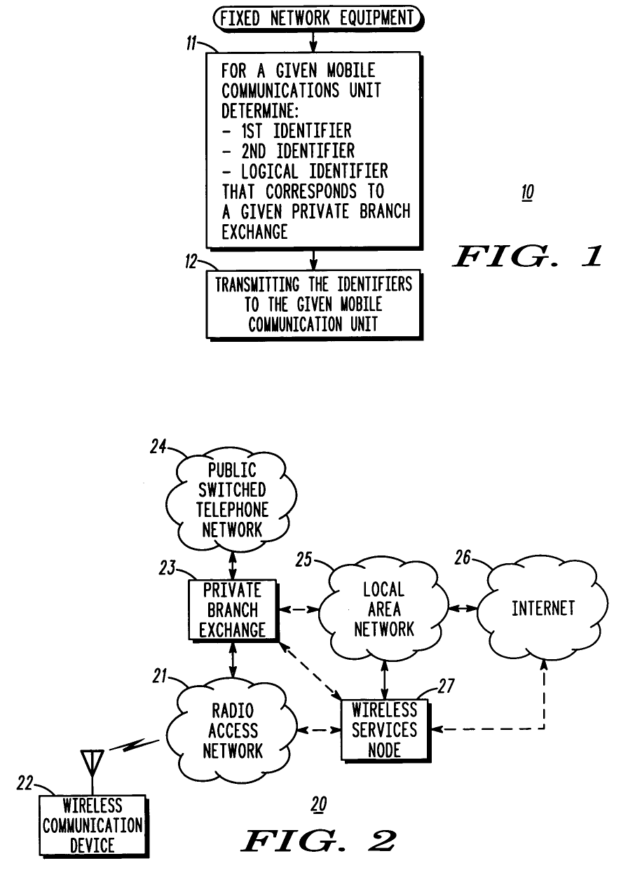

Referring now to the drawings, and in particular to FIG. 1, an illustrative process 10 to embody this capability is preferably realized via one or more elements of fixed network equipment. Various known network elements are capable of providing these provisioning services, either alone or as distributed over multiple elements and/or platforms. Many network elements are at least partially (if not wholly) programmable and such programmability can be leveraged by those skilled in the art to embody these teachings. Pursuant to one approach, a wireless services node as offered by Motorola, Inc. can serve as a suitable provisioning platform.

Pursuant to this process 10, the fixed network equipment determines 11, for a given mobile communications unit (such as a cellular telephone, a wireless local area network client, and so forth), a corresponding plurality of identifiers. In a preferred embodiment these identifiers include at least a first identifier, a second identifier, and a logical identifier that corresponds to a given private branch exchange (PBX) (that is, the logical identifier will be compatibly recognized by the given PBX as identifying the given mobile communications unit).

Such identifiers can be of any viable form and format and include, but are not limited to, uniform resource identifiers of all kinds (both as presently known and as hereafter developed and defined). To provide a non-exhaustive illustration, the first identifier can comprise a first uniform resource identifier such as a cellular telephone number while the second identifier can comprise a second uniform resource identifier such as an enterprise telephone number. Similarly, the logical identifier can comprise essentially any mobile communication device identifier. To provide a few non-exhaustive illustrative examples, the logical identifier can comprise any of:
an identifier that is identical in form and substance to one of the first or second identifiers (i.e., a duplicate to one of the other identifiers);
an identifier that is different in content from the first or second identifiers but that is an alias for one of the first or second identifiers (i.e., an identifier that maps to a same entity and/or path as one of the first or second identifiers but that has a different appearance as when an individual has numerous different email addresses that all lead to a common inbox for that individual);
a discrete, independent identifier that is unassociated with any of the other identifiers.
   Those skilled in the art will recognize that any number of such identifiers can be determined 11 by the fixed network equipment for a given mobile communication device. Only two such identifiers (in addition to the logical identifier) are depicted here for the sake of clarity.

This process 10 then provides for the transmission 12 of these identifiers to the given mobile communication device. This transmission can be effected in a variety of ways as commensurate with the resources of a given system. In a typical embodiment the transmission will likely include a wireless pathway as described below. Pursuant to one approach, this transmission can be in response to an initial registration of a given mobile communication device in a system (following, for example, authentication of the mobile communication device) though an alternative order may be preferred in some settings.

As already noted above, such a process can be embodied in any number of ways. A particular approach will likely reflect the architectural deployment choices of a given designer. FIG. 2 suggests some approaches that can be satisfactorily employed to support the above described process embodiments.

A given system 20 will typically include a radio access network (21) in accord with well understood practice to facilitate wireless communications for one or more wireless communication devices 22 (with only one such device 22 being shown in this illustration for the sake of clarity). The radio access network 21 will typically include one or more base stations (or access points) and other supporting elements to facilitate the wireless communications to and from the wireless communication devices 22 and to and from other elements in the system. Such a radio access network 21 may support, for example, wide area network services (such as cellular telephony) or wireless local area network services (such as 802.11a, 802.11b, or 802.11g wireless local area network services). Such radio access networks are well understood in the art and therefore additional elaboration will not be provided here for the sake of brevity.

In this embodiment the radio access network 21 couples to a public switched telephone network 24 via a private branch exchange 23. So configured, the wireless communication devices 22 are capable of communications via the public switched telephone network 24 with non-system landline parties, non-system wireless endpoints, and so forth. As will be described below, such communications require compatible communications between the wireless communication device 22 and this private branch exchange 23. The logical identifier provided via the above-described process serves to facilitate such communications.

In this embodiment the private branch exchange 23 also couples to a local area network 25 (such as, for example, an Ethernet local area network for a given enterprise) and, via that local area network 25, to an extranet such as the Internet 26. This embodiment also comprises a wireless service node 27 as mentioned earlier. This wireless service node 27 supports the above-described provisioning functionality. The wireless service node 27 can be coupled as appropriate to effect these services. For example, the wireless service node 27 may couple to one or more of the radio access network 21, the private branch exchange 23, the local area network 25, and even, if desired, the Internet 26. In a preferred embodiment the wireless service node 27 will be coupled in a manner that suits the configuration of the overall system to ensure that the provisioning services of the wireless service node 27 are efficiently and reliably available to ensure compatible interaction between the wireless communication device 22 and the private branch exchange 23.

Again, those skilled in the arts will quickly recognize and appreciate that the above described system embodiments are illustrative only and that many other configurations are presently possible (with many other configuration options no doubt to be expected with future developments).

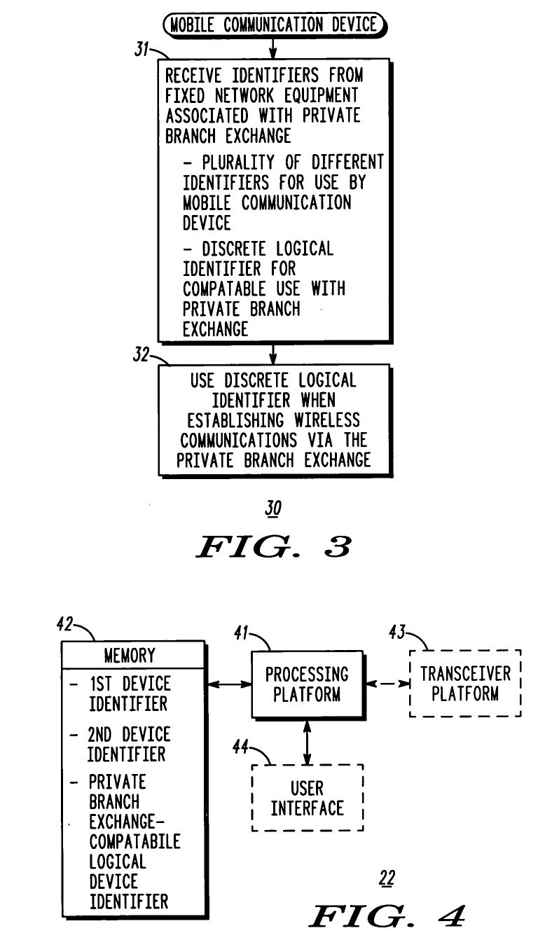

Referring now to FIG. 3, a mobile communication device can be preferably arranged, programmed, and configured to employ a reciprocal process 30 such that when the mobile communication device receives 31 a plurality of identifiers from fixed network equipment that is associated with a private branch exchange (which identifiers comprise a plurality of identifiers that are each different from one another and that are intended for use by the mobile communication unit and further comprising a discrete logical identifier that corresponds to compatible interaction with that private branch exchange), that mobile communication device can then use 32 the discrete logical identifier when establishing wireless communications via that private branch exchange.

In many instances such a private branch exchange will support session initiation protocol. When interacting with such a private branch exchange, it may be useful or necessary to combine the logical identifier with a session initiation protocol formatted identifier. For example, the logical identifier could comprise “5551111” for a given mobile communication device and the private branch exchange could have an address domain comprising “pbx.com.” Combining this logical identifier with a session initiation protocol format might therefore yield “sip:5551111@pbx.com.” Such formatting is well understood in the art. The mobile communication device here benefits, however, by having a clear and unambiguous instruction from the fixed network equipment associated with this private branch exchange to use the contents of the logical identifier when forming such an expression.

A mobile communication device can be arranged in configured in any of a wide variety of ways to implement and benefit from these teachings. For example, and referring now to FIG. 4, a wireless communication device 22 can comprise a processing platform 41 that operably couples to memory 42. In a preferred approach (and as typifies most wireless communication devices) the processing platform 41 comprises a partially (or wholly) programmable platform that can readily be programmed and configured to effect the processes set forth herein. The memory 42, as will be well understood by those skilled in the art, can be integral to the processing platform 41 or partially or wholly discrete therefrom. Such memory 42 can also comprise a unitary platform or can be distributed over a plurality of independent memory devices. Such architectural choices are well understood in the art and require no further description here.

In a preferred approach the memory 42 serves to retain the received identifiers including the private branch exchange-compatible logical device identifier. A typical embodiment will further provide a transceiver platform 43 to facilitate reception of such identifiers as described above and transmission of a message to the private branch exchange that makes use of the logical identifier as is also described above. In a preferred approach, the processing platform will effect such storage, retrieval, message formation, and transmission control as described above. For example, the processing platform 41 can serve to retrieve the logical identifier from memory 42 and use that logical identifier in a session initiation protocol-compatible format when communicating via the private branch exchange.

So configured, a mobile communication device, without system-specific design, customization, or undue reprogramming, can operate compatibly with a private branch exchange and thereby gain essentially transparent access to a public switched telephone network and corresponding services and capabilities. While receiving identifiers that can benefit the mobile communication device with respect to accessing other services supported by one or more systems, the device also receives the clear and unambiguous means to effect such private branch exchanges without additional resource commitment, training, or overhead expenditure. As but one example, these teachings permit the fixed network equipment of a given system to tune a given subscriber's session initiation protocol identity (that is, that subscriber's address-of-record) to accommodate the proclivities of a specific private branch exchange without requiring other modification to or system-specific re-programming of that subscriber.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

1. A method for use with a mobile communication device comprising:
receiving from fixed network equipment that is associated with a private branch exchange (PBX) information that corresponds to compatible interoperation with that private branch exchange;
using the private branch exchange (PBX) information when establishing communications via the PBX.

2. The method of claim 1 wherein receiving the private branch exchange (PBX) information further comprises:
receiving from fixed network equipment that is associated with a private branch exchange (PBX):
a first uniform resource identifier for use by the mobile communication device;
a second uniform resource identifier that is different from the first uniform resource identifier for use by the mobile communication device;
a logical uniform resource identifier for use by the mobile communication device;
and wherein using the private branch exchange (PBX) information when establishing communications via the PBX further comprises:
using the logical uniform resource identifier when establishing communications via the PBX.

3. The method of claim 2 wherein the first uniform resource identifier comprises a cellular telephone number.

4. The method of claim 2 wherein the second uniform resource identifier comprises an enterprise telephone number.

5. The method of claim 2 wherein the first uniform resource identifier comprises a cellular telephone number and the second uniform resource identifier comprises an enterprise telephone number.

6. The method of claim 2 wherein the logical uniform resource identifier is identical to one of the first and second uniform resource identifiers.

7. The method of claim 2 wherein the logical uniform resource identifier comprises an alias.

8. The method of claim 7 wherein the alias maps to one of the first and second uniform resource identifiers.

9. The method of claim 2 wherein the logical uniform resource identifier comprises an independent identifier.

10. The method of claim 9 wherein the independent identifier corresponds to a target that is associated with at least one of the first and second uniform resource identifiers.

11. The method of claim 9 wherein the independent identifier does not correspond to a target that is associated with either of the first and second uniform resource identifiers.

12. The method of claim 2 wherein using the logical uniform resource identifier when establishing communications via the PBX further comprises combining the logical uniform resource identifier in a session initiation protocol formatted identifier.

13. A method for use with a mobile communication device comprising:
receiving from fixed network equipment that is associated with a private branch exchange (PBX):
a plurality of identifiers for use by the mobile communication device, wherein each of the plurality of identifiers are different from one another;
a discrete logical identifier as corresponds to compatible interaction with the PBX;
using the discrete logical identifier when establishing wireless communications via the PBX.

14. The method of claim 13 wherein the plurality of identifiers includes at least one of a cellular telephone number and an enterprise telephone number.

15. The method of claim 14 wherein the plurality of identifiers includes both of a cellular telephone number and an enterprise telephone number.

16. The method of claim 13 wherein the discrete logical identifier is identical to one of the plurality of identifiers.

17. The method of claim 13 wherein using the discrete logical identifier when establishing wireless communications via the PBX further comprises using the discrete logical identifier in a session initiation protocol compliant identifier.

18. A mobile wireless communications device having:
a processing platform;
a memory operably coupled to the processing platform, wherein the memory has stored therein:
a first device uniform resource identifier;
a second device uniform resource identifier that is different from the first device uniform resource identifier;
a private branch exchange (PBX)-compatible logical device uniform resource identifier that is identical to one of the first and second device uniform resource identifiers.

19. The mobile wireless communications device of claim 18 wherein the processing platform comprises means for using the private branch exchange (PBX)-compatible logical device uniform resource identifier when communicating via a corresponding PBX.

20. The mobile wireless communications device of claim 19 wherein the first device uniform resource identifier comprises a cellular telephone number and the second device uniform resource identifier comprises an enterprise telephone number.

21. The mobile wireless communications device of claim 20 wherein the process platform comprises means for using the private branch exchange (PBX)-compatible logical device uniform resource identifier in a session initiation protocol-compatible format when communicating via a corresponding PBX.

22. The mobile wireless communications device of claim 18 and further comprising receiver means operably coupled to the memory for receiving the first device uniform resource identifier, the second device uniform resource identifier, and the private branch exchange (PBX)-compatible logical device uniform resource identifier from fixed network equipment.

23. A method for use with fixed network equipment comprising:
determining, for a given mobile communications unit, a corresponding:
first uniform resource identifier;
a second uniform resource identifier that is different than the first uniform resource identifier;
a logical uniform resource identifier that corresponds to a given private branch exchange (PBX);
transmitting to the given mobile communications unit the first uniform resource identifier, the second uniform resource identifier, and the logical uniform resource identifier.

24. The method of claim 23 wherein the first uniform resource identifier comprises a cellular telephone number.

25. The method of claim 23 wherein the second uniform resource identifier comprises an enterprise telephone number.

26. The method of claim 23 wherein the first uniform resource identifier comprises a cellular telephone number and the second uniform resource identifier comprises an enterprise telephone number.

27. The method of claim 23 wherein the logical uniform resource identifier comprises an identifier that is identical to one of the first and second uniform resource identifers.

28. The method of claim 23 wherein the logical uniform resource identifier comprises an alias.

29. The method of claim 28 wherein the alias maps to one of the first and second uniform resource identifiers.
